(19) United States
(12) Patent Application Publication
(10) Pub. No.: US 2012/0163565 A1
(43) Pub. Date: Jun. 28, 2012

(54) METHOD AND SYSTEM FOR GENERATING AND PRESENTING VOICE REFERENCE RECORDINGS

(76) Inventors: Weihui Li, Natick, MA (US); Tao Zhang, Natick, MA (US)

(21) Appl. No.: 13/329,267

(22) Filed: Dec. 17, 2011

Related U.S. Application Data
(60) Provisional application No. 61/427,398, filed on Dec. 27, 2010.

(51) Int. Cl. G10L 19/00; H04M 1/658

(52) U.S. Cl. 379/88.09; 379/88.17; 379/88.08; 704/201; 704/E19.001

(57) ABSTRACT

An automated method and system are described for obtaining and sharing references and testimonials for individuals and companies. A voice sharing system is provided which obtains and shares voice reference recordings from reference granters for a reference requester. Reference receivers can then listen to a voice reference recording by selecting an icon on a web page. A reference requester can be an individual who needs references as part of an employment search. A reference requester may alternatively be a company needing a testimonial about their products or services.

### RELATED APPLICATIONS

This application claims the benefit of U.S. provisional patent application “Method And System for Generating and Presenting Voice Reference Recordings” Ser. No. 61/427,398, filed Dec. 27, 2010. The foregoing application is hereby incorporated by reference in its entirety

### FIELD OF INVENTION

This application relates generally to web pages and more specifically to generating and presenting voice reference recordings.

### BACKGROUND

References and testimonials may be obtained for individuals, products, and companies. References are often provided for an individual when they are looking for employment, when applying to an educational institution, or when starting in a new position, whether the position be paid, an internship, or voluntary. A testimonial is often provided for a service or product provided by a company. In each case the reference or testimonial is provided by an individual about someone or something. Collectively, these references and testimonials will be generally referred to as references. These references are often difficult to utilize as people need to interact with other people. A reference can be provided where a potential employer calls an individual and the individual provides a verbal statement about another person. The time that the employer is calling must coincide with when the individual is available. If there are a group of possible employers and a group of people providing references the number of interactions become very large and can be rather burdensome on the people providing the references.

Testimonials are often used in radio or television advertising. An individual makes a statement about the value of a product or a company. The statement is broadcast to the audience of a given radio or television program. The cost for producing and broadcasting such a testimonial advertisement are significant. The advertisement also is quite problematic in that the timing of the advertisement is very specific and the target audience may only be reached in a limited fashion.

### SUMMARY

References and recommendations may be obtained and stored in computer systems for future use. The system may be referred to as a voice sharing system. Using phones and client computers, reference requesters, reference granters, and reference receivers may easily interact with the voice sharing system to request, grant, and receive recommendations. A computer implemented method is disclosed for voice storage comprising: defining a reference object for which a reference is to be provided; receiving a voice recording, which is for the reference, from a reference granter; associating the voice recording with the reference object; generating an icon corresponding to the voice recording; associating the icon with the voice recording; and displaying the icon on a webpage that is viewable to a reference receiver. The method may further comprise obtaining a code input to identify the reference granter. The reference object may be one of an individual, a specialty of the individual, a company, a service of the company, and a product of the company. The method may further comprise receiving a video recording with the voice recording. The video recording may be recorded with a webcam. The video recording may be recorded with a camera phone. A voice reference submission record may be deleted, but is not modifiable, by the reference granter and a reference requester. In some embodiments, the reference receiver may be a different party from the reference granter and a reference requester. The method may further comprise playing the voice recording to the reference receiver when the icon is selected. The playing of the voice recording may require a password be entered in order to access the voice recording. The method may further comprise recording the voice recording using a telephone call. The recording may be restricted. The telephone call may be restricted to be received from a pre-defined telephone number. A password may be required before the voice recording is recorded. The voice recording may be restricted to being recorded in a specific time frame. The voice recording may be obtained using a microphone and a computer system. The method may further comprise recording a video of a person making the voice recording wherein the recording of the video is accomplished using a webcam. The voice recording may be stored on a server device and the icon is selected on a client device. The reference may be a personal reference. The reference may be a product or service review. The reference may be a product or service recommendation. The reference may be a testimonial about a company. The reference may be a company review. At least one of a phone number and a code number may be used to prevent fraud. The voice recording may be made publicly available. The voice recording may be shared within a group. The voice recording may be provided privately to an individual. An API may be used by another website to retrieve the voice recording.

In some embodiments, a computer implemented method for voice storage may comprise: registering with a voice sharing system which stores voice recordings; obtaining a reference ID from the voice sharing system; receiving a phone call from a reference granter where the reference granter provides the reference ID that was received from the voice sharing system; recording the voice of the reference granter; and saving the recording of the voice to an audio file. The method may further comprise receiving contents of the audio file and playing the contents of the audio file. The contents of the audio file may be played to a reference receiver. In embodiments, a computer implemented method for voice storage may comprise: receiving a registration from a reference requester; receiving a reference object definition for an object on which a reference is to be provided wherein the reference object definition comes from the reference requester; receiving a voice recording for the object from a reference granter wherein the voice recording includes a recommendation; and providing the voice recording to a reference receiver.

In embodiments, a computer program product may be embodied in a non-transitory computer readable medium that, when executed, performs steps of: defining a reference object for which a reference is to be provided; receiving a voice recording, which is for the reference, from a voice reference granter; associating the voice recording with the reference object; generating an icon corresponding to the voice recording; associating the icon with the voice recording; and displaying the icon on a webpage that is viewable to a reference receiver.

In embodiments, a computer system for voice storage may comprise: a memory for storing instructions; one or more processors attached to the memory wherein the one or more processors are configured to: define a reference object for which a reference is to be provided; receive a voice recording, which is for the reference, from a voice reference granter; associate the voice recording with the reference object; generate an icon corresponding to the voice recording; associate the icon with the voice recording; and display the icon on a webpage that is viewable to a reference receiver.

Various features, aspects, and advantages of numerous embodiments will become more apparent from the following description.

### BRIEF DESCRIPTION OF THE DRAWINGS

The following detailed description of certain embodiments may be understood by reference to the following figures wherein:

FIG. 1 is a diagram of a voice sharing system.

FIG. 2 is a diagram of a voice sharing system emphasizing phone interactions.

FIG. 3 is a flow diagram from recording to playing of a voice reference.

FIG. 4 is a flow diagram for voice reference obtaining.

FIG. 5 is a flow diagram for obtaining voice references using phone interfaces.

FIG. 6 is a flow diagram for a third party accessing a reference audio.

FIG. 7 is a flow diagram for using imported product information

FIG. 8 is a flow diagram for verifying a reference granter phone number.

FIG. 9 is a diagram showing an example account settings page.

FIG. 10 is a diagram showing an example reference settings page.

FIG. 11 is a diagram showing example privacy level settings for private references on a web page.

FIG. 12 is a diagram showing example privacy level settings for public references on a web page.

FIG. 13 is a diagram showing an example references obtained page.

FIG. 14 is a diagram showing an example references granted page.

FIG. 15 is a diagram showing an example third party view page.

FIG. 16 is a flow diagram for handling recommendations wherein the handling is from a server perspective.

FIG. 17 is a system diagram for presenting recommendations.

### DETAILED DESCRIPTION

The present disclosure provides a description of various apparatus, methods, and systems associated with storing of voice recordings which provide references or testimonials for people, services, products, or companies. References or recommendations can be challenging to obtain and yet are crucial for business and job applicants as well as in numerous other situations. A recommendation can be obtained for an individual when they are applying for a job, applying to an educational institution, or the like. Recommendations can be very useful for contractors, products of a company, services of a company, and so on. This disclosure describes a computer implemented method for collecting and organizing recommendations for future reference. By collecting and storing these recommendations, it becomes much easier to obtain a recommendation from someone, also known as a reference granter. Because the recommendations are recorded and stored, people can grant and receive recommendations asynchronously, even across different time zones. Throughout this disclosure the words reference, testimonial, and recommendation should be considered interchangeable. By using the concepts disclosed herein, the ability to obtain and use references is vastly improved. The ease with which a reference may be provided can even make it far more likely that a key individual will provide such a reference.

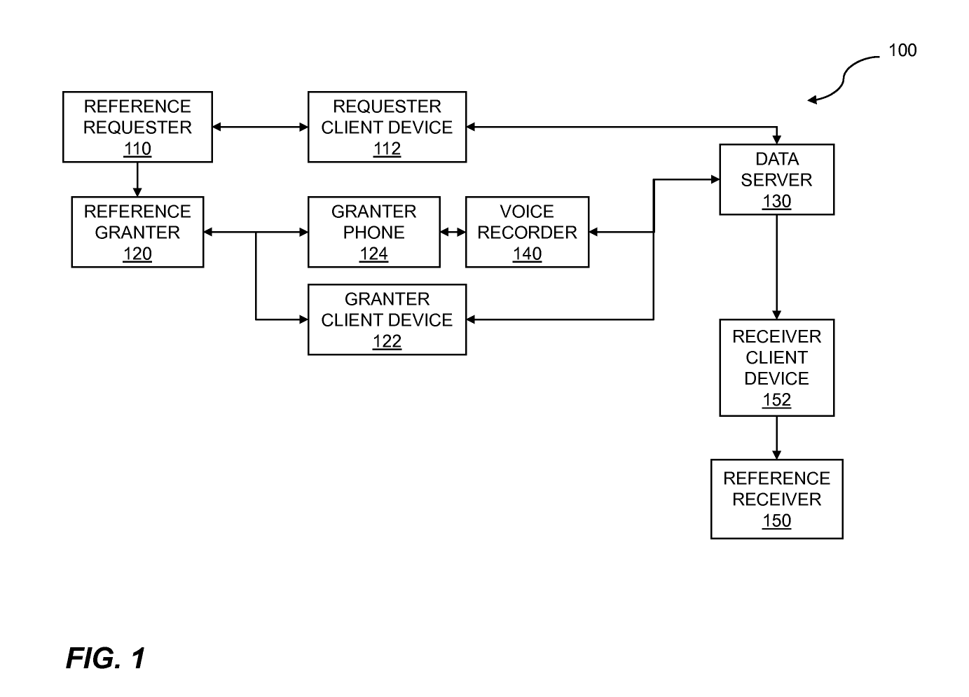

FIG. 1 is a diagram of a voice sharing system 100. FIG. 1 includes a reference requester 110, a reference granter 120, and a reference receiver 150. A reference requester 110 may be a person or a company which would like to obtain a reference or testimonial. A reference granter 120 will be a person who is willing to grant a reference. The reference granter 120 may be an individual or may be a person representing a company or organization. The reference granter 120 may be speaking on behalf of such a company or organization or may be speaking on behalf of another individual. The reference requester 110 makes a request of a voice sharing system 100 to facilitate the obtaining of a reference. The voice sharing system 100 may include a data server 130, a voice recorder 140, a reference requester client device 112, a reference granter phone 124, and a reference granter client device 122. In some embodiments, the communications between various pieces of the voice sharing system 100 are via the Internet. The reference may be for an individual, a specialty of the individual, a company, a service of the company, and a product of the company. Any of these may be considered a reference object.

The reference requester 110 may make the request through a requester client device 112 such as a personal computer, laptop, smart phone, or some other device attached to a network. The requester client device 112 may use a web browser, a web-enabled application, an application programming interface (API), or some other software interface to facilitate reference requests. The requester client device 112 communicates with a data server 130 across a network such as the Internet or an intranet. The data server 130 acknowledges the request from the requester client device 112 and may provide information back to the reference requester 110 that the reference requester 110 may in turn provide to the reference granter 120 or reference receiver 150. The information may include phone numbers, web page addresses, entry codes, and passwords. In embodiments, the reference requester 110 will give the reference granter 120 a phone number to call and a reference ID which the reference granter may input when a reference is provided. In some embodiments, the data server 130 may communicate some of this information with the reference granter 120 through the reference granter phone 124, the reference granter client device 122, or by other means. The reference granter 120 may dial the phone number on a granter phone 124, or some other phone, and hear a voice prompt. The voice prompt may simply be a request to provide a voice reference after a tone is heard. The voice prompt may request a reference ID. The granter phone 124 may be connected, by cellular communication or wires, to a voice recorder 140 which records the voice reference recording and provides the voice reference recording to the data server 130. The voice recorder 140 may use a voice over internet protocol (VOIP) system. The voice recorder 140 may communicate with the data server 130 across a network such as the Internet or an intranet. In some embodiments, the reference granter 120 may communicate a reference through a granter client device 122. The granter client device 122 may be a personal computer, laptop, smart phone, or some other device attached to a network. The voice recording may be obtained using a microphone and a computer system on the granter client device 122. The granter client device 122 may communicate with the data server 130 across a network such as the Internet or an intranet. In some embodiments, the reference granter client device 122 may communicate with the voice recorder 140.

In some embodiments, a voice reference recording may also include recording a video of a person making the voice recording wherein the recording of the video is accomplished using a webcam. The voice reference recording may be stored on a server device and presented when an icon is selected on a client device. In various embodiments, the reference is a personal reference, a product or service review, a product or service recommendation, a testimonial about a company, or a company review.

A reference receiver 150 may listen to or view the references provided by accessing the data server 130 through a receiver client device 152. The receiver client device 152 may be a personal computer, laptop, smart phone, or some other device attached to a network. The receiver client device 152 may use a web browser, a web-enabled application, an API, or some other software interface to facilitate viewing or listening to references. In some embodiments, the reference receiver 150 may store the reference recording for later listening or viewing. The stored references may be further manipulated or edited in some embodiments. Further, an API may be used by another website to retrieve the voice reference recordings.

Some of the terms and concepts used in system 100 are included below. A reference object may include a specialty of a person or a company. The reference object may also be a product of a company which is being recommended, testified to, or reviewed. In some embodiments, the reference object is a capability or personality of a person which is being recommended to help in a job search. A reference object may include a company or the features of a company product.

A reference requester may be a person or a company who requests a reference. A reference service phone number may be a phone number that a reference granter dials to record a voice reference recording. A reference granter phone number may be the number of a phone that a reference granter uses to dial into the voice sharing system 100. A voice sharing system may include a public switched telephone network (PSTN) or VOIP phone call center. The voice sharing system may provide one or more voice reference service phone numbers for a reference granter to dial in, guide the reference granter to provide a reference ID, obtain the reference granter voice recording, save the voice recording as a reference audio file, and create a voice reference entry. A time frame may be provided for the reference granter to access the voice sharing system to provide the voice reference.

A voice reference entry may include the content of a voice audio file, the reference time, the reference granter phone number with which reference granter dials into the voice sharing system, the contact information about reference granter and other related information about the voice reference. Since the reference time and the reference granter phone number may be acquired and saved by the voice sharing system, the voice reference entry may, in some instances, act as evidence of the occurrence of a voice reference so that fraud may be prevented. For each reference object, the reference requester may obtain more than one voice reference entry from a plurality of reference granters. A voice sharing system may include a website allowing a reference requester and/or reference granter to register and configure profiles. Based on the profiles, various third parties may be allowed to access the voice reference entries related to the reference requester or reference granter. A third party may be anyone who requests access to a voice reference entry. Third parties may include recruiters evaluating job applicants, potential customers of a company, or university admission committee members who want information on an applicant.

A user account may include an account created by users of a voice sharing system. A user account will have a unique user ID (also known as a web ID) and password which may be used on a web page to log into the voice sharing system and manage account setting. The account may also have a unique user phone ID and phone password. The phone ID and password may be used to identify oneself on the voice sharing system as a reference granter while making the reference recording on the phone call. The account may also have one or more reference IDs with which a user, acting as a reference requester, can request voice reference from a reference granter. Each reference ID may be associated with one reference object which may receive one or more voice references.

A user phone ID may consist of phone key inputs, generally digital numbers, which are associated with a user and which are unique in the voice sharing system. A user phone ID may include a phone number for the user. A reference granter may use his or her user phone ID to identify themselves when dialing into the voice sharing system to make a voice reference. A user phone password may consist of phone key inputs, generally digital numbers, which are associated with a user and are used by a reference granter to prevent interlopers from using just a phone ID to dial into the voice sharing system to make a fraudulent voice reference. A user web ID may consist of the characters input from computers, cell phones, or other devices which can access the Internet. The user web ID is unique in the voice sharing system. The user web ID can be different from or the same as the phone ID. The user web ID may be an email address as long as it is unique within the voice sharing system. A user web password may be a password for a user to log into their user account in the voice sharing system.

A reference ID may consist of phone key inputs, generally digital numbers, which are associated with a reference object and which are unique in the reference recording and sharing system. A reference requester obtains a reference ID when he or she defines a reference object on the voice sharing system. A reference requester may have one or more reference IDs.

A public reference may be any voice reference that is appropriate for public consumption such as a company testimonial or a product review. A private reference may be any voice reference which is specifically authorized. A private reference may, for example, be a personal reference. A reference sharing key may be a password for use by a third party to access reference entries when the reference requester or reference granter wants to keep their voice reference entry private. There is no need for a reference sharing key for any public reference.

A voice reference may be recorded and easily shared on the Internet for personal or company use. A voice sharing system may be based on a PSTN or VOIP phone call center, which provides one or more voice reference service phone numbers for a reference granter to dial in. After dialing in, the system guides the reference granter to identify oneself and/or the reference object, obtains the reference granter voice reference recording, saves the voice reference as a reference audio file, and creates a voice reference entry.

A voice sharing system may include a website allowing a reference requester and reference granter to register and configure a profile, allowing a third party to access the voice reference entry. This approach is a vast improvement over obtaining traditional references. In a traditional reference or testimonial routine, after a reference requester told a third party the reference granter's phone number, a reference granter might receive multiple reference calls from various third parties. Sometimes, if the reference granter has not been in contact with the reference requester for a long time, the reference granter may lack a current impression about the reference requester and not know what to say on behalf of the reference requester. Also, a traditional reference may require the reference granter and the third party to make an appointment for the reference call, providing added burden on the reference granter.

The voice reference procedure for the voice sharing system has numerous innovative features: 1) being able to record a reference once which then can be accessed numerous times; 2) easily making a voice reference on a phone and then being easily shared on the Internet; and 3) making a voice reference at the reference granter's convenience with the voice reference entry being almost instantly available for use.

A reference sharing key may be set as a combination of characters and be associated with one or more reference IDs. A third party can use the reference sharing key to access the voice reference entry of one or more reference objects. In detail, there are two ways to achieve this sharing. In the voice sharing system, the reference sharing key may be unique in the system. A third party can use the reference sharing key to access the voice reference entry of a reference object. Given that the reference sharing key is unique in the voice sharing system, the reference requester can change the reference sharing key to protect privacy and further to avoid access by a previous third party who had access using a former reference sharing key. Alternatively, in the voice sharing system, the reference sharing key may not be unique and may be associated with multiple reference IDs as a password. The third party may need to input the reference sharing key and reference ID to access the voice reference entry. A reference requester can always change the reference sharing key to protect the privacy or avoid the access right of previous third party who knows the former reference sharing key.

In this way, for a private reference, the system has innovative features including those listed below. A reference requester may only let a third party with a specific reference sharing key access to a reference entry so that voice reference privacy is protected. A reference requester can avoid the access of a previous third party who had a reference sharing key by changing it to a new one. If there are more than one reference objects or reference IDs for a reference requester, multiple reference sharing keys may be generated which are different from each other. In such a way, a third party might only have limited access rights with one given sharing key.

For even more convenience, a voice sharing key may be associated with several reference objects or reference IDs. In this case, a third party may access the reference entry of several or all of the reference objects.

For a private reference, a voice sharing key may be used to protect a voice reference entry. For a public reference, no voice sharing key may be needed. A third party can use a user ID of a reference requester to access all of the reference entries or use reference IDs to access a voice reference entries of a given reference object.

A reference ID may be fixed, partially configurable, or fully configurable. It may be changed or changed partially if a reference requester finds spam voices being entered. A configurable reference ID may prevent strangers from inputting a reference ID to make spam voice reference.

When a reference granter makes a reference call for a reference requester, the voice sharing system records the voice reference, the reference granter's phone number, and the reference time. If a reference granter does not identify his or her info on the voice sharing system, in some embodiments, the reference requester can add some comments as background data for the reference entry. Beyond this, the voice sharing system may allow the reference granter to identify themselves on a phone and thereby attach some additional information that is already on the granter's account profile to the voice reference entry. The extra information may include his or her address, phone number, privacy level setting, etc. Once the reference granter is identified, a previously made voice reference entry may be configured. For instance, the voice reference may be deleted.

The voice sharing system can identify the reference granter in the following ways:

a. The reference granter inputs a user phone ID and password. Alternatively, the system may simply need a user phone ID from the reference granter. If a fraudulent voice reference is found at any time, the user phone ID may be changed.

b. If the reference granter has not registered on the voice sharing system and does not have a user phone ID, the voice sharing system may assign a temporary user phone password or allow the setting of a user phone password when he calls to make a reference. At that point the reference granter can register and identify this reference entry afterward on the website using the phone number, reference ID, and the password.

c. If the reference granter cannot remember the phone ID, they might only input their phone password and, afterward, use the reference ID, reference granter phone number, and the password to identify this voice reference entry.

d. If the reference granter configures a phone number that is exclusively used by the reference granter and this phone number is verified when he or she dials into the reference recording system with that phone, the voice sharing system may acquire the appropriate user phone ID according to the phone number in the system and skip the step of identification of the reference granter phone ID.

e. After a reference requester obtains a reference, if the reference granter is not identified, the requester can send an email notice through the voice sharing system to the reference granter and let the reference granter confirm the occurrence of the voice reference. At this point, if the reference granter has not registered in the system, the voice sharing system will guide the reference granter to register and then identify the reference granter. If the reference granter has already registered on the voice sharing system, he can just confirm the occurrence of the voice reference on the voice sharing system and identify as the reference granter.

Once the reference granter is identified, the system may provide the function as following:

a. The reference granter can manage the voice reference entry they created. For example, the voice reference may be deleted or the privacy level setting changed.

b. The profile of the voice reference granter in the voice sharing system may be associated with the voice reference entry and a third party may see more information about the reference granter.

c. A reference phone password may prevent a stranger from making a fraudulent voice reference.

A reference requester may have the capacity to do voice reference entry management. For a reference requester who has only one reference object, there may be only one purpose for the voice receiver to get a voice reference. For instance, the reference requester may only access references in one field of work. There may be no classification issue for these reference objects.

For a reference requester who creates more than one reference object and therefore has more than one reference ID, voice reference entries may be accessed in a category format similar to that of a directory system in computer. A third party may use a reference ID to access reference entries from a specific category. Alternatively, the third party may use a reference requester web ID to access all reference entries, again in a similar fashion to that of a file directory systems in a computer. The third party may be able to view the voice references for each reference ID under a category. A reference sharing key may be needed if the voice reference requester sets the voice reference as being private.

Reference IDs may be organized in a directory format. Third parties may access the classified voice reference entries, depending on authorization. Reference requesters can also set categories and manage the voice reference entries on a category by category basis.

After a reference requester obtains a list of reference entries for one reference object, the reference requester can manage them as needed. He or she may change the display order of voice reference entries when the voice reference entries are shown to a third party. The reference requester may decide if he or she wants a specific voice reference entry displayed or hidden for a specific third party. In embodiments, the reference requester can also delete the voice reference entries as well. In some embodiments, the reference requester has the capacity to do voice reference entry management.

The voice sharing system may log a reference time and a reference granter phone number. This information may be shown to a third party as evidence that the voice reference did occur and thereby further prevent fraudulent voice reference. In such a way, a reference entry on the voice sharing system not only serves as the voice reference content storage but also as a proof that the reference granter called and recorded one or more references, testimonials, or reviews through a reference service phone number. Thus, the use of reference granter phone numbers along with the time and dates of recordings for the audio files may further provide evidence of the validity of the reference recordings. The voice reference may also be typed in afterward or automatically converted to text characters to let the third party rapidly browse to get a quick idea of the contents of the voice recording.

The voice sharing system may have a rich API to make the voice reference entry sharing easily available on social network websites or job hunting websites etc. APIs may also allow company testimonial voice files to be shown on a company website where the voice files can be linked and played. The voice sharing system may also provide reference entries for other websites to let third parties directly access the recordings.

A reference requester may categorize reference objects, like company products. The reference requester may import product data files with product IDs from their website or elsewhere. The reference requester may, in this manner, associate reference recordings with further product information in the voice sharing system. In this way, the reference ID for their products is linked to the product ID for their website, making it convenient for their website to further call a voice reference API.

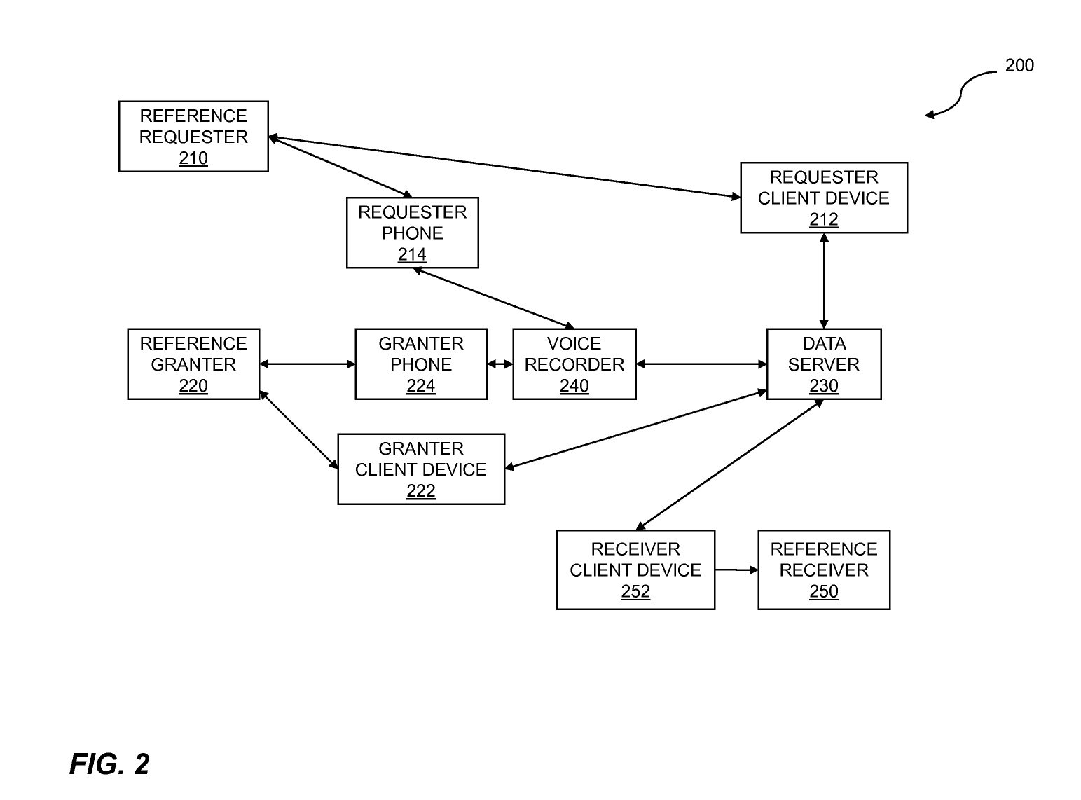

FIG. 2 is a diagram of a voice sharing system 200 emphasizing phone interactions. FIG. 2 includes a reference requester 210, a reference granter 220, and a reference receiver 250. A reference requester 210 may be a person or a company which would like to obtain a reference or testimonial. A reference granter 220 may be an individual or may be a person representing a company or organization who is willing to grant a reference. The reference requester 210 makes a request of a voice sharing system 200 to facilitate the obtaining of a reference. The voice sharing system 200 may include a data server 230, a voice recorder 240, a reference requester client device 212, a reference requester phone 214, a reference granter phone 224, a reference granter client device 222, and a receiver client device 252. In some embodiments, the communications between various pieces of the voice sharing system 200 are via the Internet or other network.

The reference requester 210 may make the request through a requester client device 212 such as a personal computer, laptop, smart phone, or some other device attached to a network. The requester client device 212 may use a web browser, a web-enabled application, an application programming interface (API), or some other software interface to facilitate reference requests. The requester client device 212 communicates with a data server 230 across a network. The data server 230 acknowledges the request from the requester client device 212 and may provide information back to the reference requester 210. Besides the way that the reference requester 210 gives the reference ID to reference granter 220 to call the service phone number in FIG. 1, the reference requester 210 can use a requester phone 214 to call the service phone, input the reference ID, input the reference granter phone number, and let voice sharing system forward the phone to reference granter 220 through reference granter phone 224. Then the reference requester 210, the reference granter 220, and the voice sharing system can start a three-sided phone call. The reference requester may ask the reference granter to make a reference. After the reference granter 220 agrees to make a reference, the reference requester 210 might push a phone key to start a voice prompt. The voice prompt may simply be a request to provide a voice reference after a tone is heard. The voice recorder 240 records the voice reference recording and provides the voice reference recording to the data server 230. The voice recorder 240 may use a voice over internet protocol (VOIP) system. The voice recorder 240 may communicate with the data server 230 across a network such as the Internet or an intranet. The granter client device 222 may be a personal computer, laptop, smart phone, or some other device attached to a network. The voice recording may be obtained using a microphone and a computer system on the granter client device 222. The reference granter 220 might use the granter client device 222 to communicate with the data server 230 across a network such as the Internet or an intranet. In some embodiments, the reference granter client device 222 may communicate with the voice recorder 240.

A reference receiver 250 may listen to or view the references provided by accessing the data server 230 through a receiver client device 252. The receiver client device 252 may be a phone, a smart phone, mobile device, tablet computer, laptop computer, net book, or the like.

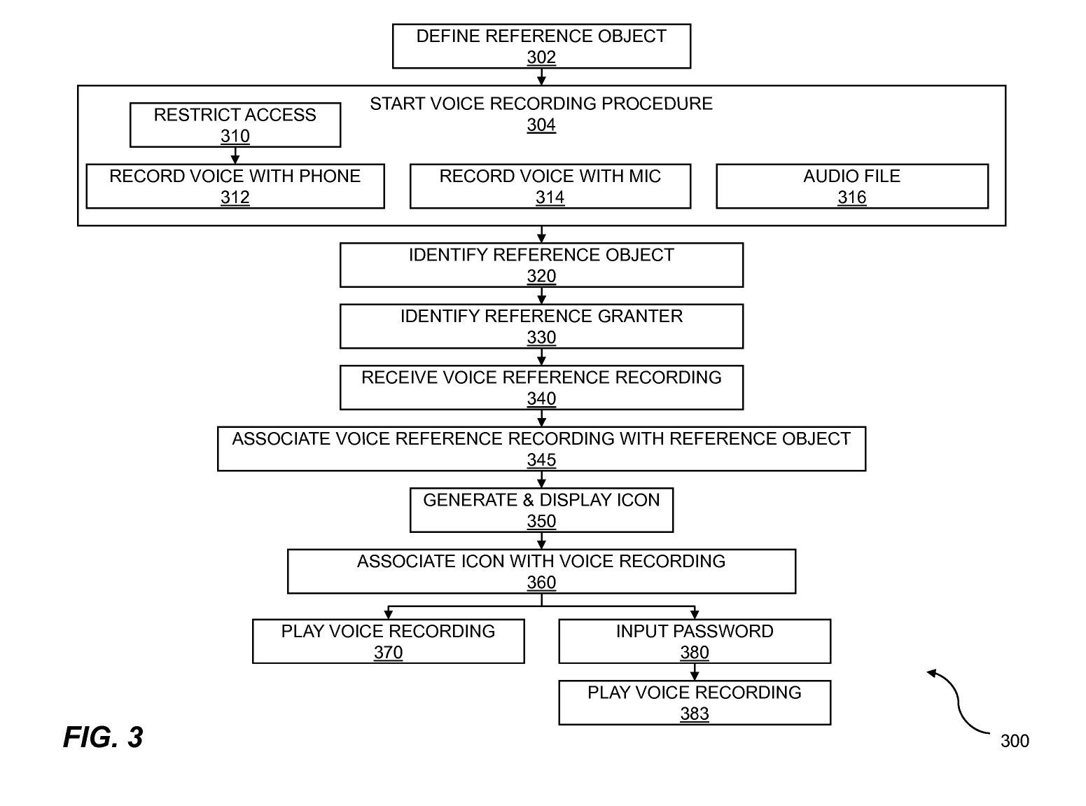

FIG. 3 is a flow diagram from recording to playing of a voice reference. The flow 300 is for a computer implemented method for voice storage. The flow 300 may begin with defining a reference object 302 for which a reference is to be provided. The defining may identify a person, company, product, service, or the like for which a recommendation is to be provided. The defining may include providing model numbers, serial numbers, or other numeric or alpha-numeric indicator of the object. The object may be an aspect of a person, company, product, service, or the like where the reference to be obtained speaks to that specific aspect. The flow 300 may continue with starting a voice recording procedure 304, which is for the reference, from a reference granter. There are multiple ways to start a voice recording procedure 304. In embodiments, recording the voice recording may be accomplished using a telephone 312. The telephone may be a landline phone, a cell phone, a satellite phone, or other mobile phone or mobile device. A telephone number may be provided to the reference granter to dial in and provide a voice reference. In some embodiments, the recording of the voice with a telephone 312 is preceded by restricting of access 310 by a telephone so that the recording is restricted. For instance, a restriction can be placed where only a specific telephone number or set of telephone numbers may be used to dial in to provide a voice reference. Another restriction may be placed where a voice reference may only be provided during a specific time interval. Other restrictions may include requiring a user phone ID after dialing the telephone to provide the voice reference or requiring a user phone ID and password. In some embodiments, a voice is recorded with a microphone 314. The microphone may be attached to a computer system, such as through a USB cable or audio jack, and the recording of a voice reference may be accomplished locally on a client device or may be streamed to a server. Along with recording of the voice, the recording may include receiving a video recording as part of the reference. The video recording may be recorded with a webcam. The video recording may also be recorded with a camera phone. In some embodiments, both the video and audio reference recording may be accomplished with a cell phone through the microphone on a cell phone and through the camera phone. The camera phone may be either on the front side or on the back side of the phone. In other embodiments, a microphone attached to a computer system may be used to record the voice reference while a camera phone may simultaneously capture video for the reference recording.

In other embodiments, flow 300 includes obtaining an audio file 316 which contains a voice reference recording. The audio file 316 may have been obtained from another system, may have been obtained from an audio studio, may have been obtained from an advertisement, or may have been obtained in some other fashion.

The flow 300 includes identifying a reference object 320 for which a reference is to be provided. The reference object may be a company, a division of the company, a department, a service of the company, a product of the company, or a category of products or services of the company. A reference object may be a person, a service of the person, a skill of the person, or an attribute for which employers are looking for a reference. There may have been a whole series of reference objects which were defined to a voice sharing system. An example of a series of reference objects would be a group of products described in a catalog or on a web page. There may also be just a single reference object, such as a person. In this case the reference object might be a person looking for employment and therefore looking to obtain one or more references to which a potential employer can listen. If there are few products or categories, a company may create a reference ID for each of the products.

In some embodiments, a reference granter is identified 330. The reference granter may be required to enter one or more of a user ID, a user phone ID, an email address, a web address, and a password, depending on how the reference granter provides the reference. The reference granter identity may be for a single person, for a group of people, or for an individual speaking on behalf of another or a company. The reference granter identity may be used simply to access the voice sharing system or may further be stored as part of the voice reference entry. The reference granter identity may be viewable to a reference receiver, the reference requester, and the reference granter. Alternatively, the reference granter identity may only be accessible to the reference granter and the reference requester.

In some embodiments, the flow 300 continues with receiving the voice reference recording 340. In embodiments, the voice reference recording is performed prior to the identifying of the reference object 320 and identifying the reference granter 330. In other embodiments, these identifications are made and then the voice reference recording is made. The voice reference recording is stored in a computer system. The flow 300 continues with associating the voice recording with the reference object 345. The flow 300 continues with generating an icon corresponding to the voice recording and displaying the icon 350 on a webpage that is viewable to a reference receiver. Alternatively, the icon may be viewable on some other web-enabled application. The flow 300 continues with associating the icon with the voice recording 360. The flow 300 continues by playing the voice recording 370 to the reference receiver when the icon is selected. The flow may include receiving contents of an audio file and playing the contents of the audio file when the icon is selected. The contents of the audio file may be played to a reference receiver or the reference requester or even the reference granter. In some embodiments, a reference requester may tell a reference receiver to access a voice sharing system through a phone using a reference ID. In this way, website access may not be needed to hear a voice reference recording. In some embodiments, the playing of the voice recording requires a password be entered in order to access the voice recording. After the password is input 380 the voice reference recording is played 383. Various steps in the flow 300 may be changed in order, repeated, omitted, or the like without departing from the disclosed inventive concepts.

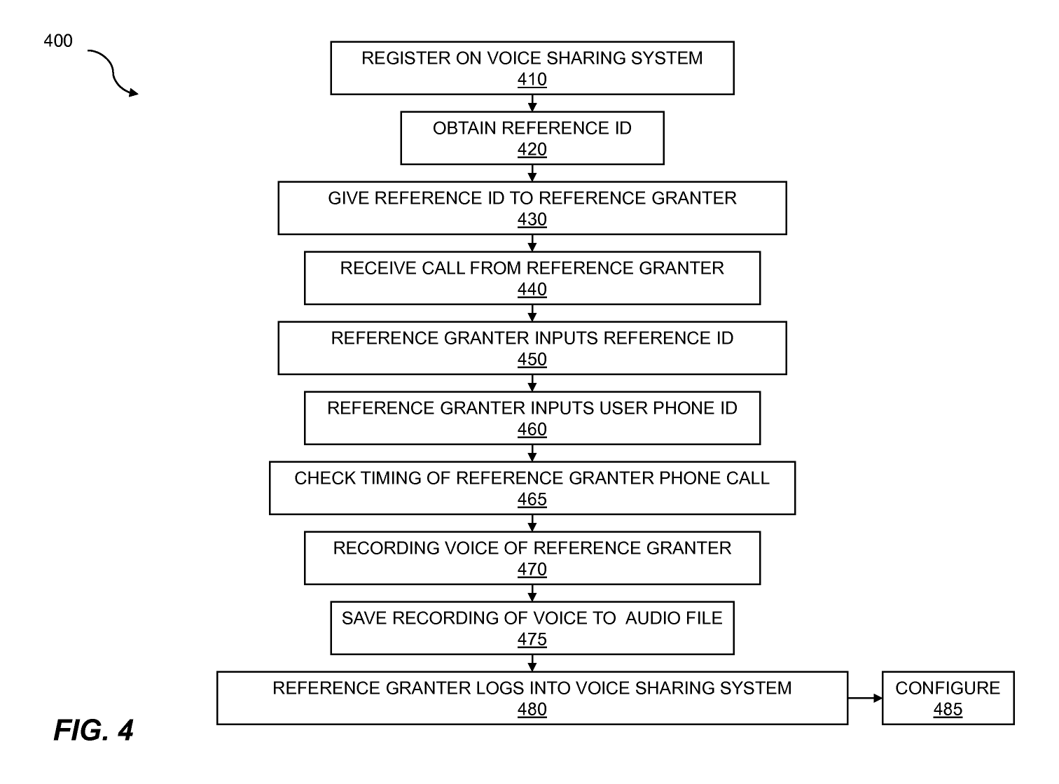

FIG. 4 is a flow diagram for voice reference obtaining. The flow 400 describes a computer implemented method for voice storage. The flow 400 begins with a reference requester registering with a voice sharing system which stores voice recordings. A reference requester will register with a voice sharing system 410 as part of a process of obtaining voice references to share with potential employers or people interested in a company, product, or service. The reference requester may be an individual looking for one or more references for employment, education, or service providing purposes. The reference requester may be a company where the reference is for the company, a service of the company, or a product of the company. The flow 400 continues with the reference requester obtaining a reference identifier (also known as a reference ID) 420 for a reference object from the voice sharing system. The reference ID will be a code which the reference requester can give to a reference granter. The reference granter can use the reference ID when calling into the voice sharing system and provide a voice reference recording. The reference ID will identify the reference object to the voice sharing system. The reference requester or the voice sharing system will give the reference ID to the reference granter 430. In many instances the person who is the reference requester will provide the reference ID to the reference granter by email, mail, phone call, or in person. In some instances, the reference requester will input the reference granter's information into the voice sharing system which will, in turn, email, mail, or in other manner communicate the reference ID to the reference granter. The flow 400 continues with the reference granter calling the voice reference service phone number so that the voice sharing system receives a call from the reference granter 440. The recording may be restricted in various fashions. The telephone call may be restricted to be received from a pre-defined telephone number. Alternatively, the reference granter may log into a web service for the voice sharing system and provide the reference ID. The flow 400 continues with the reference granter inputting the reference ID 450. The reference ID may provide the voice sharing system with information about the reference object for which a reference is to be provided. In this manner, the voice sharing system receives a phone call from a reference granter where the reference granter provides the reference ID that was received from the voice sharing system or reference requester. In some embodiments, the reference granter inputs a user phone ID 460 that identifies the reference granter to the voice sharing system. The phone ID may be associated with an individual, a group, or a company. There may be multiple levels of phone IDs. For instance, a company may be identified. Within the company a department or division may be identified. Within the company, division, or department, a person may be identified. The phone ID may be tied to a particular person or to a role. For example an administrative assistant may have a phone ID. In this manner, even though the administrative assistant may change from one person to the next, each administrative assistant may use the same phone ID. In some embodiments, a password may be required before the voice recording is recorded. At least one of a phone number and a code number may be used to prevent fraud.

The flow 400 may continue with the checking of timing for the reference granter phone call 465. In some embodiments, the voice recording may be restricted to being recorded in a specific time frame. The flow 400 continues with recording the voice of the reference granter 470. In embodiments, recording the voice recording may be accomplished by using a telephone call. The voice may be recorded using digital or analog recording techniques. The flow 400 continues with saving the recording of the voice to an audio file 475. The voice reference may be saved in MP3, WAV, WMA, VQF, OGG, or other audio file format. If video is recorded as part of the reference, the file may be saved in MP4, MPEG, WMV, FLV, MKV, MOV, 3GP, AVI, or other video format. In some embodiments, the recording 470 and saving 475 steps may be combined. The flow 400 may continue with the reference granter logging into the voice sharing system 480. In some embodiments, the reference granter reviews the voice reference recording to ensure that it communicates what he or she desires. Besides the content of a voice audio file, the reference time and the reference granter phone number may be acquired and saved as a voice reference submission record. The voice reference submission record is a part of the reference entry and cannot be modified by a reference granter or requester to prevent a fraudulent voice reference. In embodiments, a voice reference entry can be configured 485. In some embodiments, the voice reference entry can be deleted, by the reference granter and the reference requester. Further, the reference granter may provide further information about the voice reference recording that may be attached in the form of metadata or may be included in text form with the icon. Various steps in the flow 400 may be changed in order, repeated, omitted, or the like without departing from the disclosed inventive concepts.

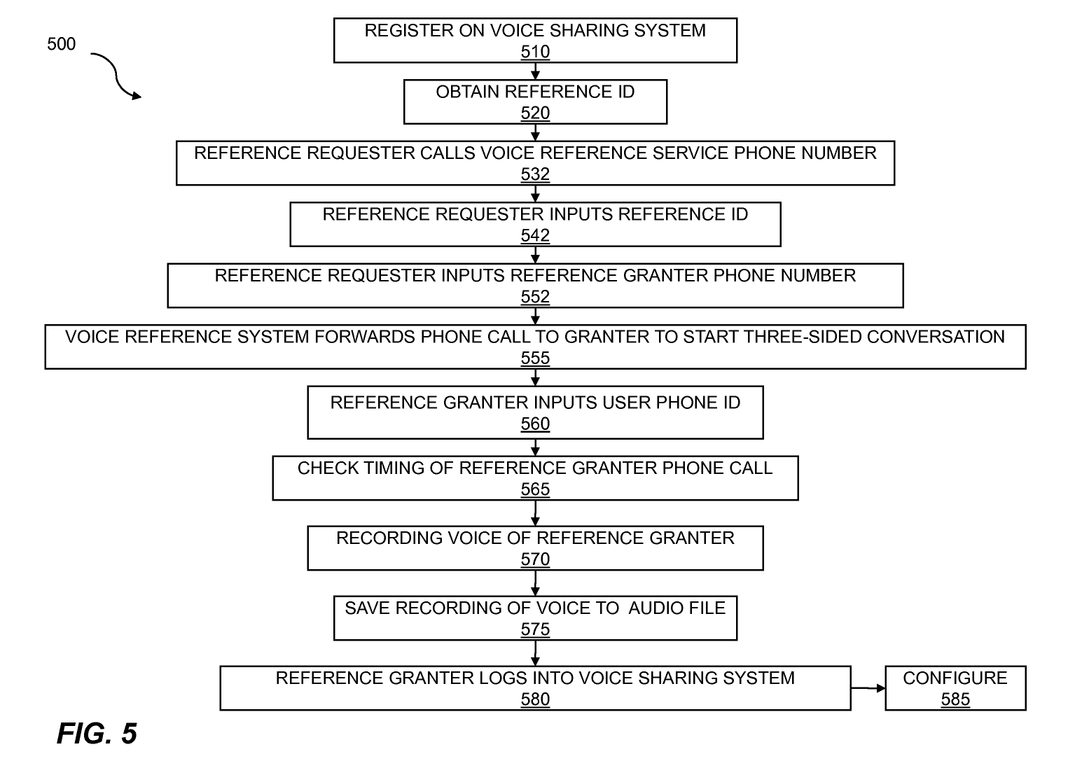

FIG. 5 is a flow diagram for obtaining voice references using phone interfaces. The flow 500 describes a computer implemented method for voice storage. The flow 500 begins with a reference requester registering with a voice sharing system which stores voice recordings. A reference requester may register with a voice sharing system 510 as part of a process of obtaining voice references to share with potential employers or people interested in a company, product, or service. The flow 500 may continue with the reference requester obtaining a reference identifier (also known as a reference ID) 520 for a reference object from the voice sharing system. The flow 500 may continue with the reference requester calling a voice reference service phone number 532 using reference requester phone or using a virtual phone software with his requester client device. The voice reference service phone number may have been provided when the reference requester registered with the voice sharing system 510. The flow 500 may continue with the reference requester inputting a reference ID 542. The reference ID may be associated with a reference object for which recommendations may be obtained. The reference ID may have been obtained when the reference requester registered with the voice sharing system 510. If the virtual phone software can be started with an icon click on a webpage which is associated with the reference ID, the reference requester might not need to input the reference ID manually. The flow 500 may continue with the voice reference system forwarding a phone call to a reference granter to start a three-sided conversation 555. The reference requester and the reference granter may both be connected on a three-way phone call with the voice recorder of the voice sharing system. In embodiments, the reference requester may talk with the reference granter and discuss the recommendation or the object for which the recommendation is to be obtained. At some point the reference requester or the reference granter may press a button on one of their phones to begin the recording of the recommendation.

In some embodiments, the reference granter may input a user phone ID 560 that identifies the reference granter to the voice sharing system. The phone ID may be associated with an individual, a group, or a company. There may be multiple levels of phone IDs. For instance, a company may be identified. Within the company a department or division may be identified. Within the company, division, or department, a person may be identified. The phone ID may be tied to a particular person or to a role. In some embodiments, a password may be required before the voice recording is recorded. At least one of a phone number and a code number may be used to prevent fraud.

The flow 500 may continue with the checking of timing for the reference granter phone call 565. In some embodiments, the voice recording may be restricted to being recorded in a specific time frame. The flow 500 continues with recording the voice of the reference granter 570. The voice may be recorded using digital or analog recording techniques. The flow 500 continues with saving the recording of the voice to an audio file 575. The voice reference may be saved in MP3, WAV, WMA, VQF, OGG, or other audio file format. If video is recorded as part of the reference, such as might be the case with a camera phone, the file may be saved in MP4, MPEG, WMV, FLV, MKV, MOV, 3GP, AVI, or other video format. In some embodiments, the recording 570 and saving 575 steps may be combined. The flow 500 may continue with the reference granter logging into the voice sharing system 580. In some embodiments, the reference granter reviews the voice reference recording to ensure that it communicates what he or she desires. Besides the content of a voice audio file, the reference time and the reference granter phone number may be acquired and saved as a voice reference submission record. The voice reference submission record is a part of the reference entry and cannot be modified by reference granter or requester. In embodiments, a voice reference entry can be configured 585. In some embodiments, the voice reference entry can be deleted, by the reference granter and the reference requester. Further, the reference granter may provide further information about the voice reference recording that may be attached in the form of metadata or may be included in text form with the icon. Various steps in the flow 500 may be changed in order, repeated, omitted, or the like without departing from the disclosed inventive concepts.

There might be other methods to simplify the reference obtaining procedure. In some embodiments, on the voice sharing system, a phone number can be designated by reference requester as being dedicated for only one reference object. In that case, once the voice reference sharing system receives a phone call from that phone number, the system associates the reference recording with the reference object and skips the reference ID input. Such an application is very useful for retail or service companies who collect volumes of recommendations from customers on site.

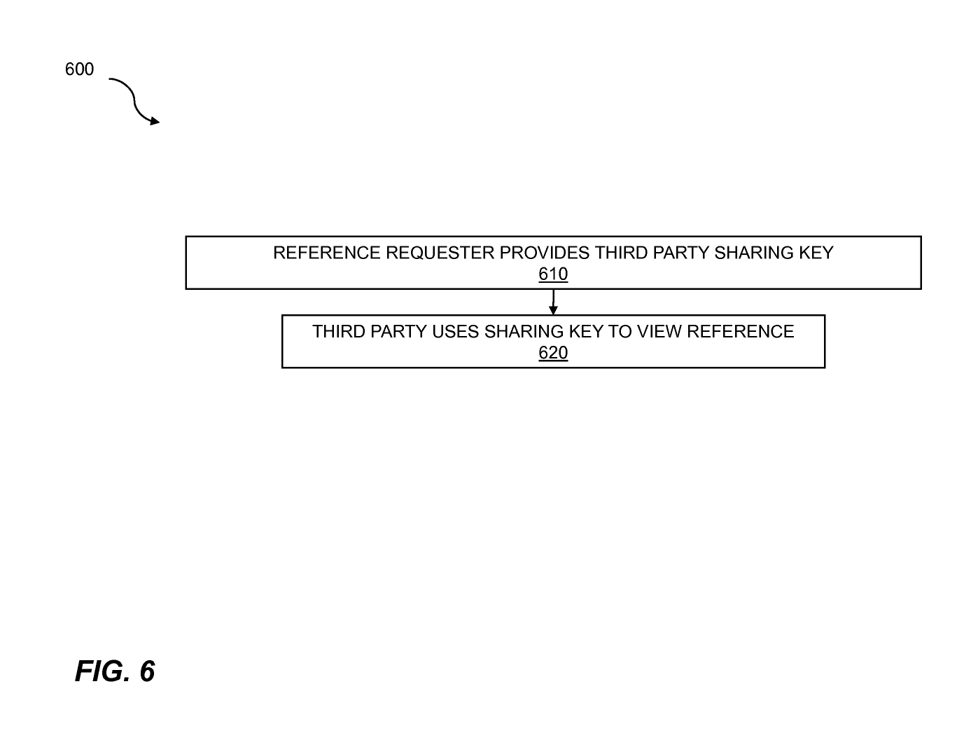

FIG. 6 is a flow diagram for a third party accessing a reference audio. The flow 600 begins with a reference requester providing a third party with a sharing key 610. The third party may be a reference receiver. The sharing key may be used so that the voice reference can be maintained as private. The flow 600 continues with the third party using the sharing key to view the reference 620. The third party may view an icon for the voice reference on a web page or other web-enabled application. The third party may select the reference and listen to the voice reference. The voice recording may be provided privately to an individual. Various steps in the flow 600 may be changed in order, repeated, omitted, or the like without departing from the disclosed inventive concepts.

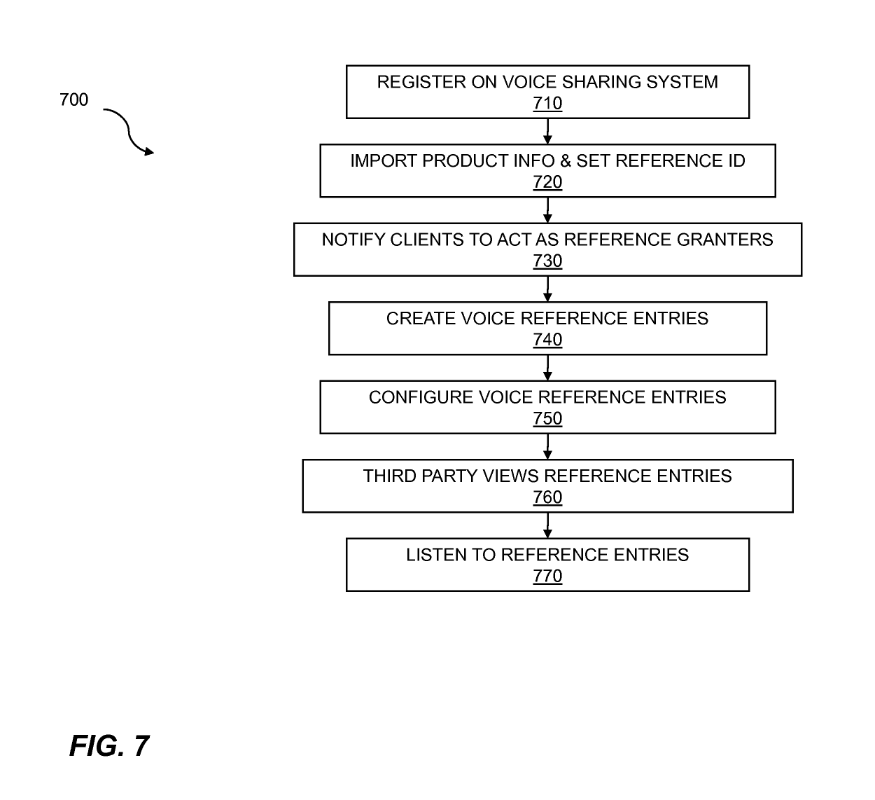

FIG. 7 is a flow diagram for using imported product information. The flow 700 begins with a reference requester registering on a voice sharing system 710. A reference requester can register on the voice sharing system so that reference granters can provide references about the various products and services that the company of the reference requester provides. Registration may include details about the individual registering and the company he or she represents. The flow 700 continues with importing of product information 720. If there are only a few products, the product information may be entered with a keyboard. With multiple products a reference requester may import product information 720 from web sites, catalog resources, files, and other resources available to the reference requester. The reference requester can then notify clients to act as reference granters 730. The notification can be done in person, by mail, by phone call, by email, by website, by Twitter™, by Facebook™ or by some other communication. In embodiments, the notification can be done automatically where the voice sharing system has a list of clients or customers. The voice sharing system would then notify the clients or customers through email or other means. The reference granters could then call or connect into the voice sharing system to create voice reference entries 740. The voice reference entries could be testimonials about the products, services, or company. The reference requester or reference granter may then configure the voice reference entries 750. In embodiments, the configuring could include the deleting entries, editing entries, arranging icons representing the entries, adding labeling around the icons, or some other arranging. The flow 700 continues when a third party views the reference entries 760. The viewing may be done on a web page or other web-enabled application. The third party may be a reference receiver or even an auditor of voice references to ensure compliance with regulations. The reference receiver may not be the reference granter nor a reference requester. The flow 700 continues with a reference receiver listening to reference entries 770. The reference receiver may listen to a single voice reference or a series of voice references. The voice recording may be made publicly available so that anyone with access to the Internet may listen to the voice references. Alternatively, the voice recording may be shared within a group or with only an individual. When sharing is limited, a user ID, password, code, or key would typically be provided. Various steps in the flow 700 may be changed in order, repeated, omitted, or the like without departing from the disclosed inventive concepts.

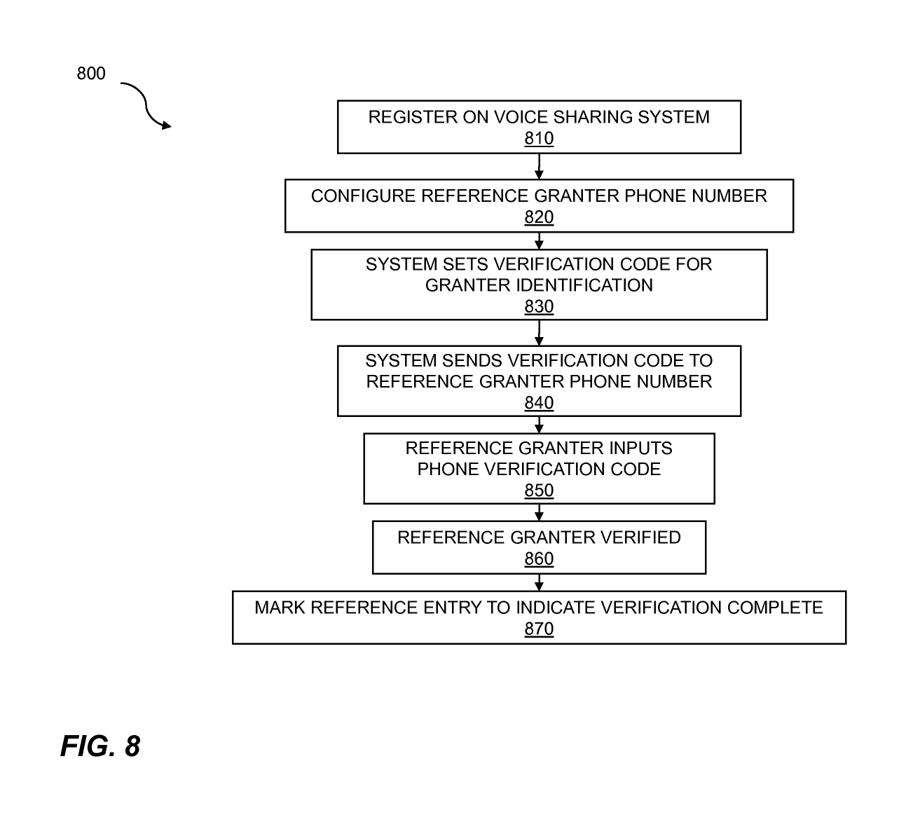

FIG. 8 is a flow diagram for verifying a reference granter phone number. In some embodiments, it may be useful to verify if a reference granter can be reachable using the phone number set in the profile, which in turn, may prevent some fraudulent references. In other embodiments, verifying a reference granter phone number may not be required when doing the reference voice recording. The flow 800 begins with a reference granter registering on a voice sharing system 810. The reference granter may be an individual or a company providing a reference for the reference requester. The flow 800 continues with the reference granter configuring the reference granter phone number 820. The configuring may include the configuring of a phone number that the voice sharing system calls in order to reach the reference granter. Alternatively, the configuring may include specifying a number or group of phone numbers from which the reference granter can call. The flow 800 may continue with the setting of a verification code for granter verification 830 by the voice sharing system. The verification code may be a series of numbers, letters, or a combination thereof. The flow 800 may continue with the voice sharing system sending the verification code to the reference granter phone number 840 by phone call, voice mail, or by text message.

The flow 800 may continue with the reference granter inputting the verification code 850 into the voice sharing system. The voice sharing system may prompt the reference granter to input the phone verification code. Alternatively, the voice sharing system may remind the reference granter to verify the granter phone number through other communication methods such as email, text message, web pages, etc.

The flow 800 continues with the reference granter being verified 860 by the voice sharing system. Once the code sent from the voice sharing system and the code the granter input to the voice sharing system matches, the reference granter phone number is verified. In embodiments, the flow 800 continues with marking the reference entry to indicate that verification was complete 870. The marking may include putting a check mark next to or as part of the icon. The marking may include changing of the color of the icon. Various steps in the flow 800 may be changed in order, repeated, omitted, or the like without departing from the disclosed inventive concepts.

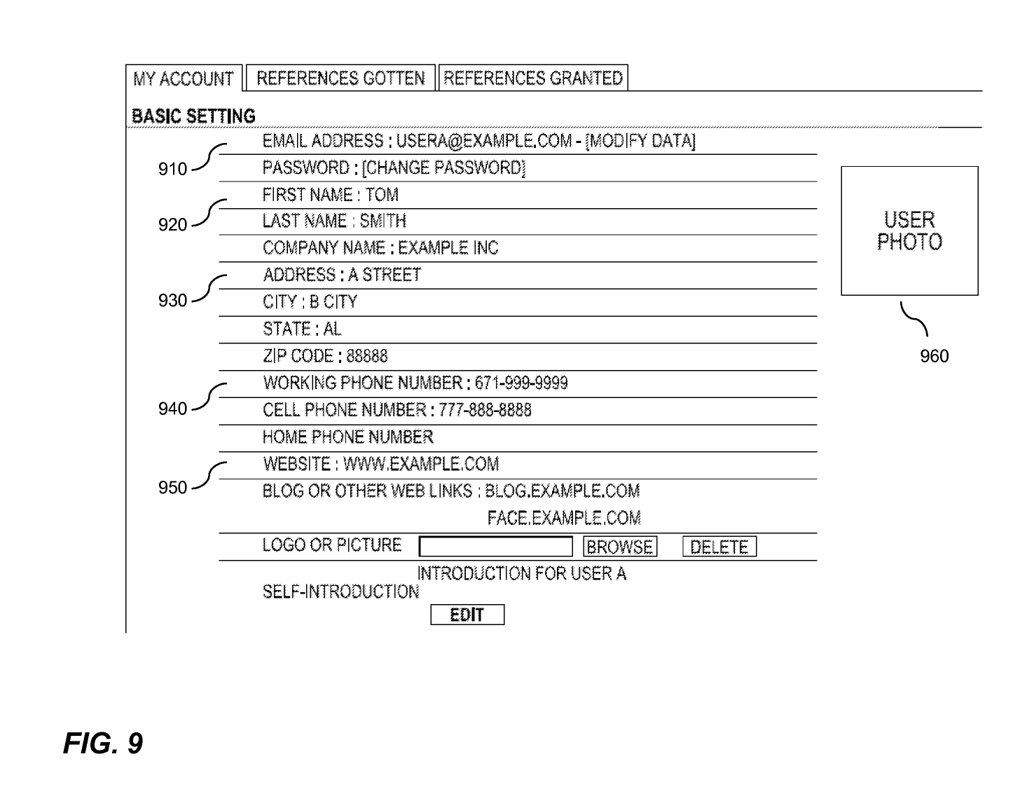

FIGS. 9 through 15 are exemplary web pages showing possible embodiments for a voice sharing system. FIG. 9 is a diagram showing an example user account settings page. A user can be a reference requester, a granter, or both. The account settings may include an email address 910, a name 920, an address 930, phone numbers 940, and a website 950. The account settings page may also include a photograph 960. The account settings page includes information for the user. The reference requester or reference granter initiates the forming of an account by registering with a voice sharing system. Other information may be included on the account settings page depending on the type of reference being obtained.

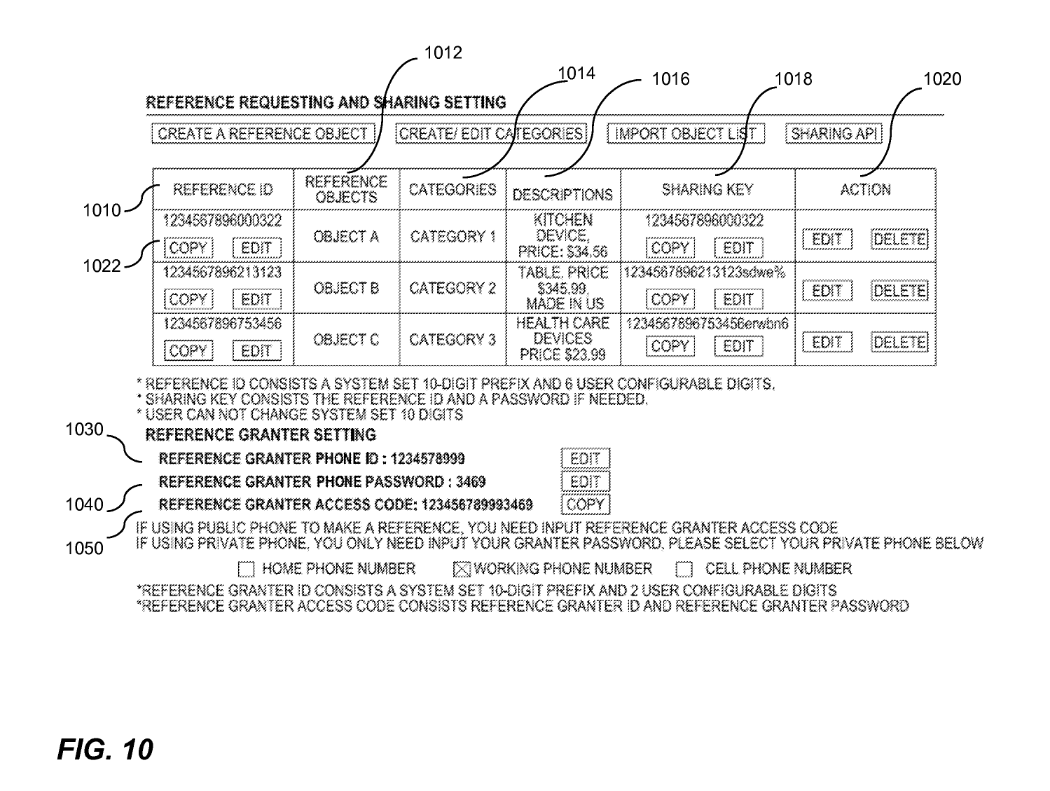

FIG. 10 is a diagram showing an example reference settings page. A reference requester may create a series of reference requests for reference objects. Each reference object will have a reference ID 1010. On the reference settings page, a reference request may list a reference ID 1010, the name of the reference object 1012, a category for the reference object 1014, a description of the reference object 1016, and a sharing key 1018 for the reference object. The sharing key 1018 may include a concatenated password for accessing a voice reference recording for the reference object. The sharing key 1018 may be used when a reference is considered private and not available to the public at large. The sharing key 1018 would be communicated to any reference receiver that the reference requester desires to be able to listen to the reference. A single sharing key may be provided for all reference objects associated with the reference requester or a separate sharing key may be provided for each reference object. A set of actions 1020 may be associated with each reference ID. The actions may include deleting the reference object or editing the reference object. Editing of the reference object could involve changing the name of the reference object or the category label for the reference object. A reference ID could have a copy 1022 button which would allow copying of the reference ID.

A reference granter would have a reference granter phone ID 1030 and in some embodiments a reference granter phone password 1040. To simplify the input, a reference granter may be allowed to combine the reference granter phone ID and reference granter phone password together as reference granter access code 1050 and input it to the voice sharing system to identify him or herself when using a public phone. Alternatively, a reference granter can use a reference granter password to identify oneself for use with the private phone numbers registered in his profile.

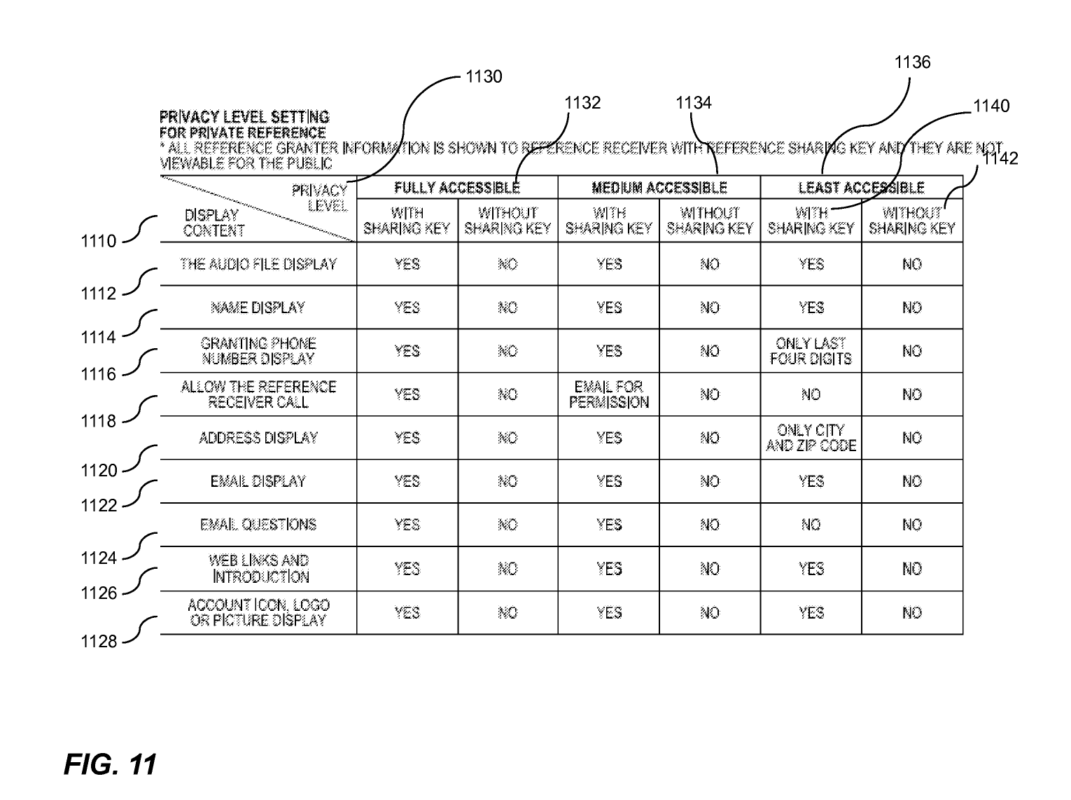

FIG. 11 is a diagram showing example privacy level settings for private references on a web page. A private reference will have limited accessibility with key information being available to those to whom it is intended. Some information will be displayed on a web page or other web-enabled application. The display content 1110 can include the audio file being displayed 1112, the name of the reference granter 1114, the reference granter phone number 1116, whether a reference receiver is allowed to call 1118, the address of the reference granter 1120, the email of the reference granter 1122, the ability of a reference receiver to email questions to the reference granter 1124, web links for and an introduction about the reference granter 1126, and account setting information for the reference requester 1128. A setting may be selected for each reference object making the object fully accessible 1132, making it medium accessibility 1134, and making it least accessible 1136. For each of these accessibility levels different permissions would be granted with 1140 and without 1142 the sharing key 1018. Different setting values may be used for different types of references.

In some embodiments, a privacy level setting 1130 may be set by a reference granter. The privacy setting may define the amount of access allowed by third parties to a reference granter's information and whether the reference granter wants a reference receiver to contact with him or her. For example, a reference granter may choose to display, partially display, or hide his/her physical working address, email or phone number when a third party accesses the voice reference recording entry. The reference granter may also set a preferential contact method, like email, phone or regular mail, for a reference receiver to contact with questions regarding the voice reference recording.

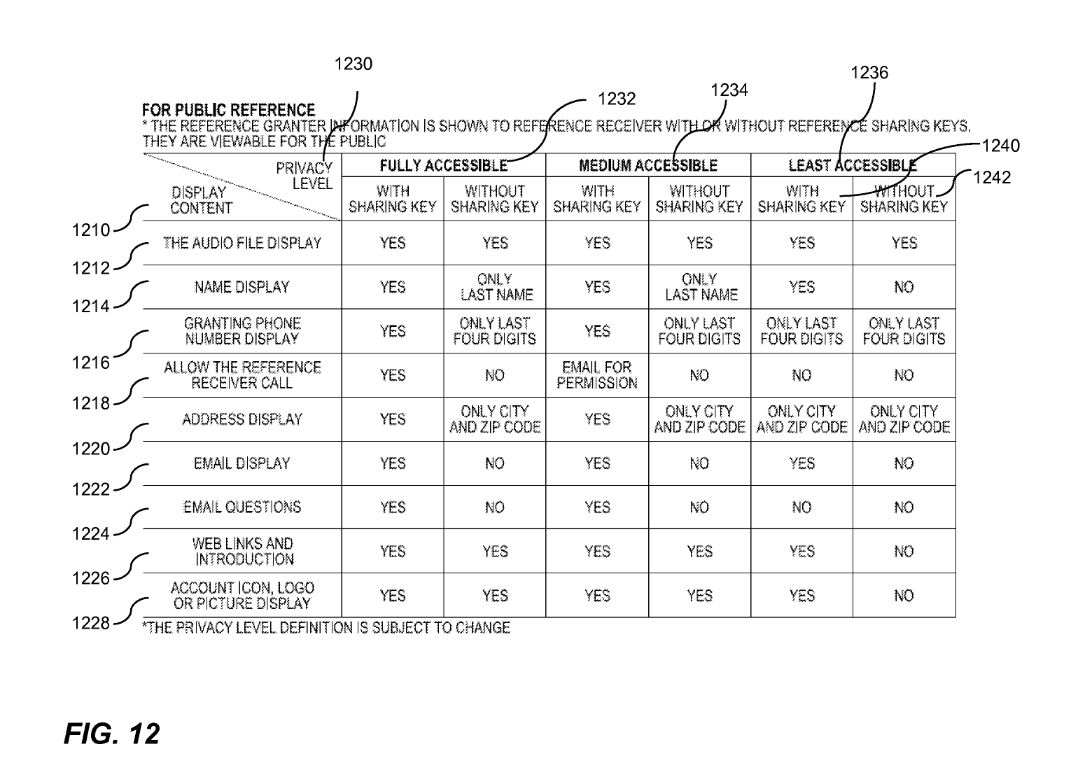

FIG. 12 is a diagram showing example privacy level settings 1230 for public references on a web page. A public reference will be generally available to the public. Nevertheless, while the voice reference recording will be publicly available, much information about the reference granter may be limited. Some information will be displayed on a web page or other web-enabled application. The display content 1210 can include the audio file being displayed 1212, the name of the reference granter 1214, the reference granter phone number 1216, whether a reference receiver is allowed to call 1218, the address of the reference granter 1220, the email of the reference granter 1222, the ability of a reference receiver to email questions to the reference granter 1224, web links for and an introduction about the reference granter 1226, and account setting information for the reference requester 1228. A setting may be selected for each reference object making the object fully accessible 1232, making it medium accessibility 1234, and making it least accessible 1236. For each of these accessibility levels different permissions would be granted with 1240 and without 1242 the sharing key 1218. Different setting values may be used for different types of references.

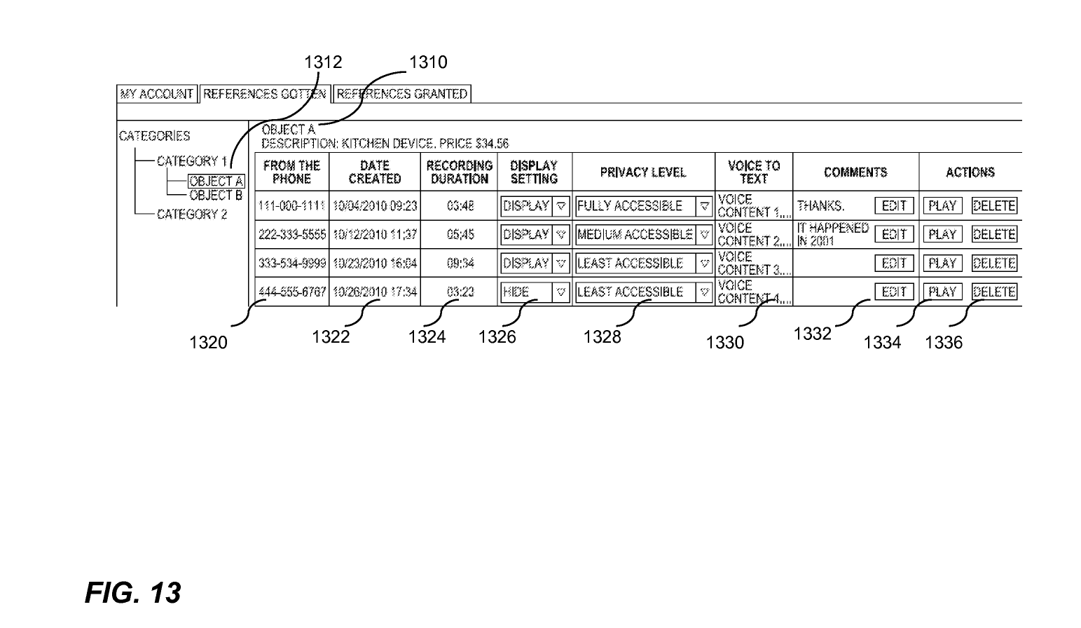

FIG. 13 is a diagram showing an example references obtained page. For a given reference requester, a list of references obtained may be displayed on a web page. This web page may only be accessible to the reference requester. The list of references will include the reference object name 1310. A list of categories 1312 may be included. The categories may be shown in a tree structure. Categories may include, for example, types of products, types of service, or other groupings of reference objects. References obtained for the reference object may be listed. The information on the references obtained may include the phone number from which the reference was granted 1320, the date on which the reference was granted 1322, and the duration of the voice reference recording 1324. The display setting 1326 may be selected allowing information on the reference to be displayed or hidden. A privacy level for the specific voice reference recording may be selected 1328. In some embodiments, a voice to text option 1330 may be provided. The voice to text option may provide a full text display of the voice reference recording. Alternatively, a few summary points from the voice reference recording may be shown in text. The text may be displayed on this references obtained web page or may be shown on a web page accessible to the reference receivers. Comments 1332 from the reference granter may be shown. Actions for the voice reference recording may include playing 1334 the voice reference recording or deleting 1336 it.

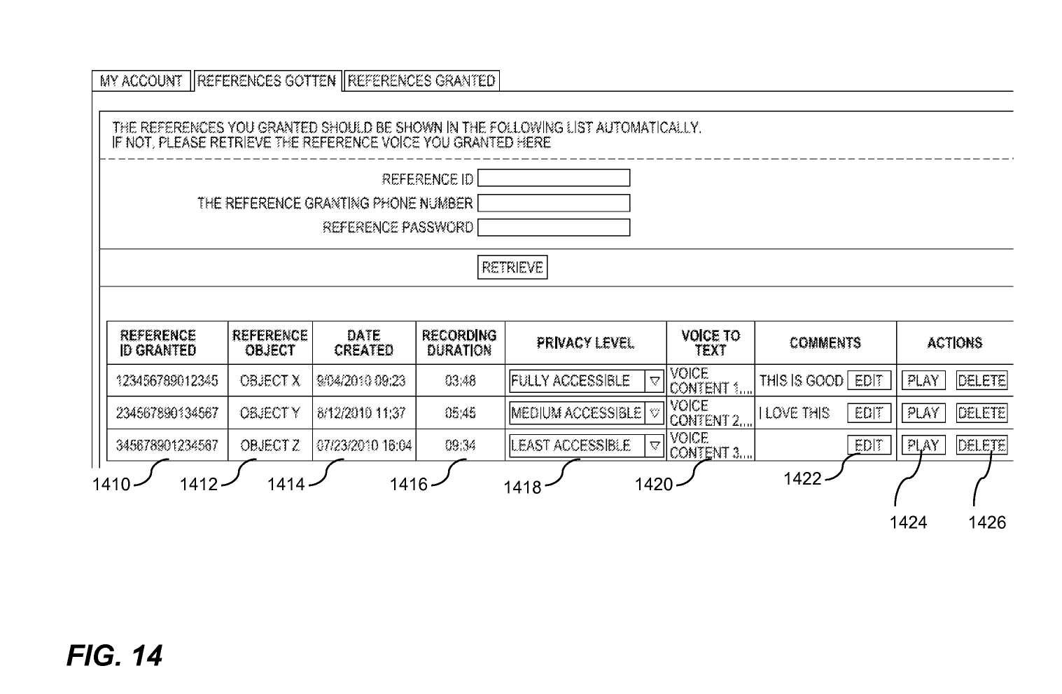

FIG. 14 is a diagram showing an example references granted page. A references granted page may be accessible to a reference granter. The information displayed may include the reference ID 1410, the name of the reference object 1412, the date on which the voice reference recording was created 1414, and the duration of the voice reference recording 1416. A privacy level 1418 for the voice reference recording entry may be selected. Voice to text may be displayed 1420 for the voice reference recording. The voice to text option may provide a full text display of the voice reference recording. Alternatively, a few summary points from the voice reference recording may be shown in text. The text may be displayed on this references obtained web page or may be shown on a web page accessible to the reference granters. Comments 1422 from the reference granter may be shown. Actions for the voice reference recording may include playing 1424 the voice reference recording or deleting 1426 it.

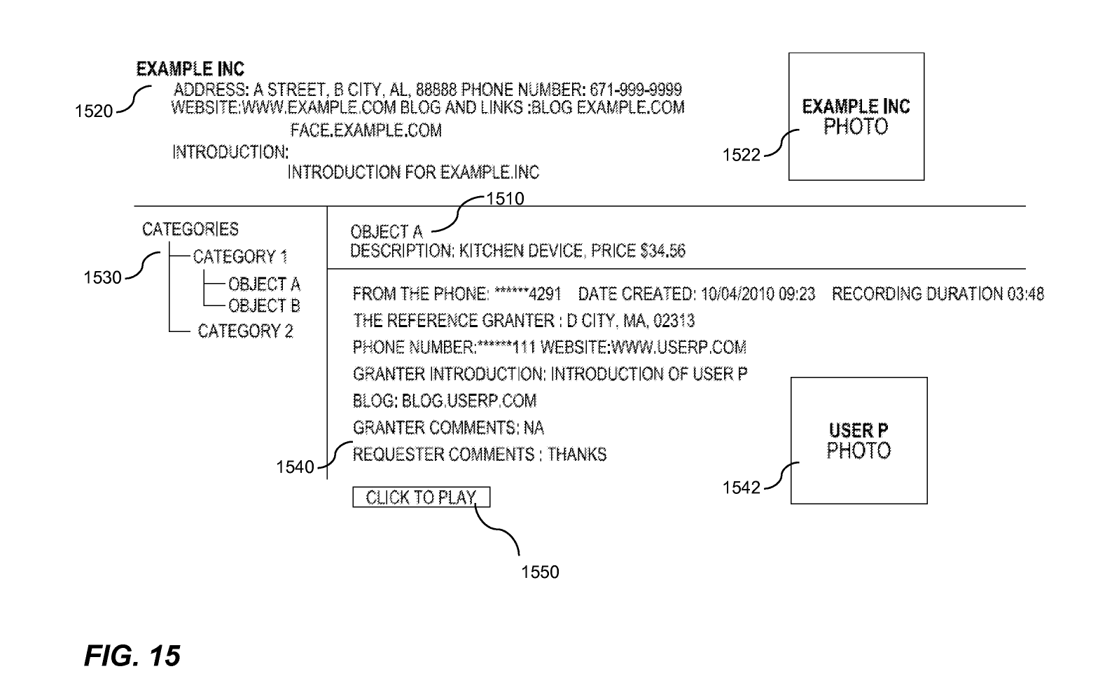

FIG. 15 is a diagram showing an example third party view page. The example page may be viewable by a reference receiver. The reference object name 1510 might be displayed. In some embodiments, a company 1520 associated with the reference object may be displayed. A photo or a logo 1522 of the requester may be shown. A photo of the reference object may be displayed as well. The categories 1530 may be listed or shown in tree format. Information 1540 about the reference granter may be shown. A photograph 1542 of the reference granter may be display as well. A button 1550 or icon may be selected for playing the voice reference recording. By clicking on the button or icon the voice reference recording will be heard. If a video recording was included, the video reference will be displayed.

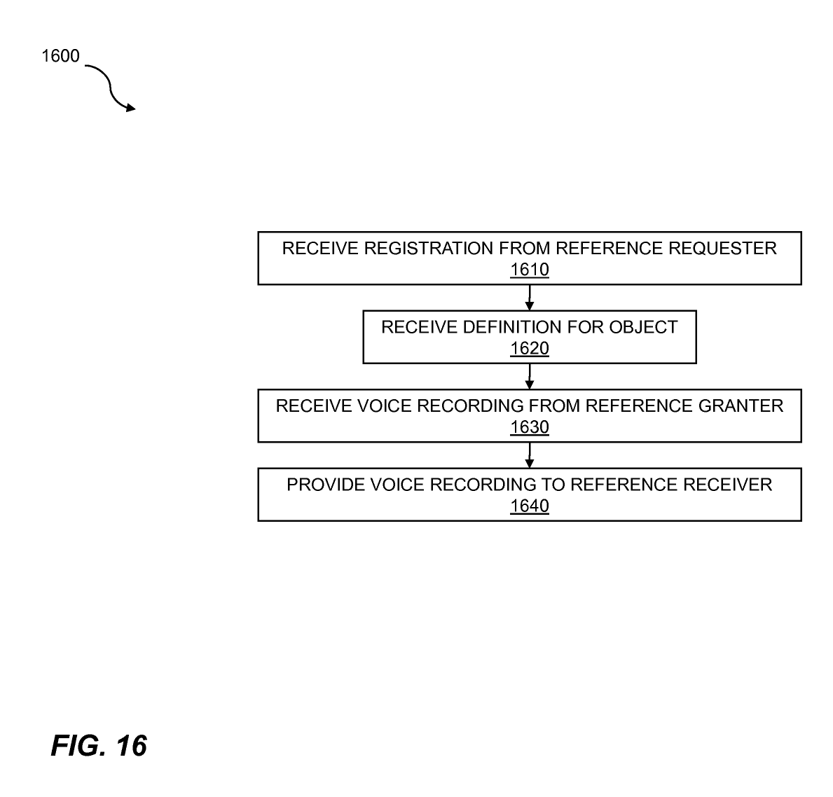

FIG. 16 is a flow diagram for handling recommendations wherein the handling is from a server perspective. The flow 1600 describes a computer implemented method for voice storage. The flow 1600 begins with receiving a registration from a reference requester 1610. A reference requester may register with a voice sharing system as part of a process of obtaining voice references. The flow 1600 continues with receiving a reference object definition 1620 for an object on which a reference is to be provided wherein the reference object definition comes from the reference requester. The reference object may be a company, a division of the company, a department, a service of the company, a product of the company, or a category of products or services of the company. A reference object may be a person, a service of the person, a skill of the person, or an attribute for which employers are looking for a reference. There may have been a whole series of reference objects which were defined to a voice sharing system. An example of a series of reference objects would be a group of products described in a catalog or on a web page. There may also be just a single reference object, such as a person. In this case the reference object might be a person looking for employment and therefore looking to obtain one or more references to which a potential employer can listen. The definition for the reference object may be a description of the object, a part number, a person's name, a company's name, and so on. Part of the definition may be the code or entry in a computer system so that voice recordings and other recommendation data may be received. The flow 1600 continues with receiving a voice recording for the object from a reference granter 1630 wherein the voice recording includes a recommendation. The voice reference recording may be received from a telephone, a client computer, and so on. The flow 1600 continues with providing the voice recording to a reference receiver 1640. The voice recording for a recommendation, recorded by a reference granter, may be played for the reference receiver. Various steps in the flow 1600 may be changed in order, repeated, omitted, or the like without departing from the disclosed inventive concepts.

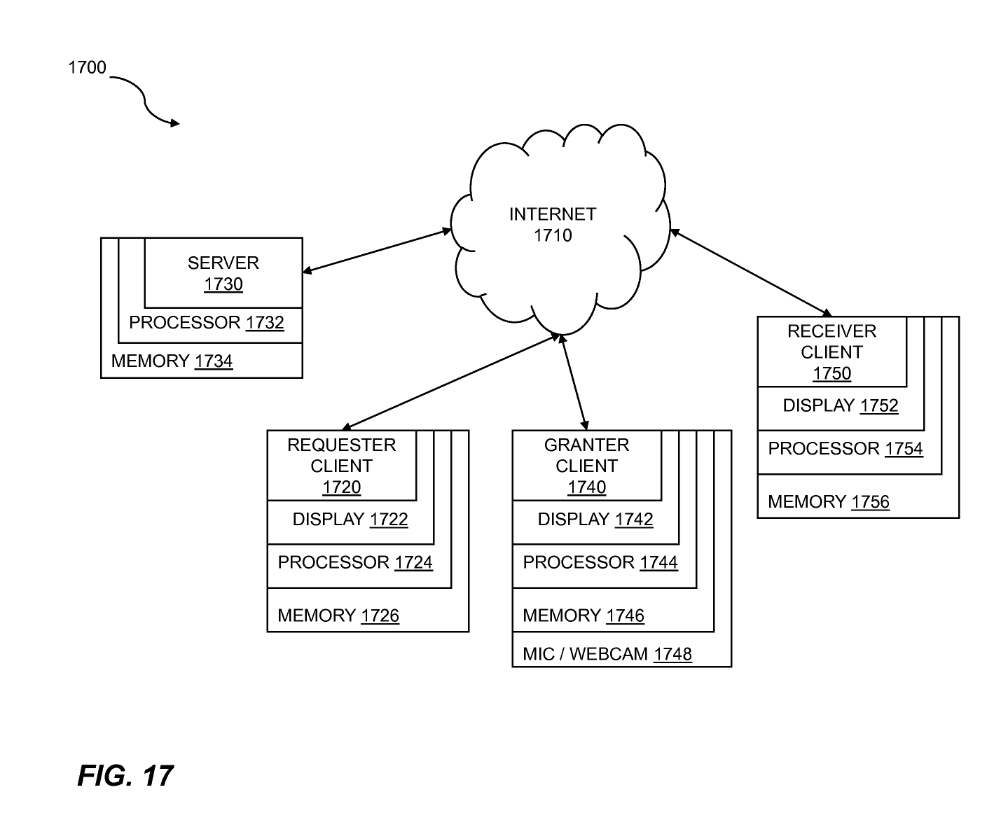

FIG. 17 is a system diagram for presenting recommendations. A system 1700 may include the Internet 1710, a requester client 1720, a server 1730, a granter client 1740, and a receiver client 1750. The Internet 1710, intranet, or other computer network may be used for communication between the various computers. A requester client 1720 machine has a memory 1726 which stores instructions, and one or more processors 1724 attached to the memory 1726 wherein the one or more processors 1724 can execute instructions stored in the memory 1726. The memory 1726, which may comprise one or more memories, may be used for storing instructions, for storing voice recordings and other recommendation data, for temporary storage, for system support, and the like. The requester client 1720 also may have an Internet connection to carry requests and recommendations and a display 1722 that may present various information on the recommendations and objects to which the recommendations pertain. In some embodiments, the requester client may be a phone, a smart phone, mobile device, tablet computer, laptop computer, net book, or the like.

The requester client 1720 may communicate a registration request, an object definition, and the like to a server 1730 machine. The server 1730 may have a connection to the Internet to enable handling of requests, definitions, voice recordings, and the like. Further, the server 1730 may have a memory 1734 which stores instructions and one or more processors 1732 attached to the memory 1734 wherein the one or more processors 1732 can execute instructions. The memory 1734, which may comprise one or more memories, may be used for storing instructions, for storing requests and definitions, for storing voice recordings and other recommendation data, for temporary storage, for system support, and the like. The server 1730 may use its Internet, or other computer communication methods, to obtain voice recordings, provide voice recordings, and so on.

A granter client 1740 machine has a memory 1746 which stores instructions, and one or more processors 1744 attached to the memory 1746 wherein the one or more processors 1744 can execute instructions stored in the memory 1746. The memory 1746, which may comprise one or more memories, may be used for storing instructions, for storing voice recordings and other recommendation data, for temporary storage, for system support, and the like. The granter client 1740 also may have an Internet connection to carry requests and recommendations and a display 1742 that may present various information on the recommendations and objects to which the recommendations pertain. The granter client has a microphone, and in some embodiments a webcam 1748, for recording the granter as he or she provides a recommendation for voice recording. As indicated, a face, part of a body, or the whole body may be recorded with a webcam or other camera device. In some embodiments, the granter client 1740 may be a phone, a smart phone, mobile device, tablet computer, laptop computer, net book, or the like.

A receiver client 1750 machine has a memory 1756 which stores instructions, and one or more processors 1754 attached to the memory 1756 wherein the one or more processors 1754 can execute instructions stored in the memory 1756. The memory 1756, which may comprise one or more memories, may be used for storing instructions, for storing voice recordings and other recommendation data, for temporary storage, for system support, and the like. The receiver client 1750 also may have an Internet connection to carry requests and recommendations and a display 1752 that may present various information on the recommendations and objects to which the recommendations pertain. The display 1752 may be used to view recommendations when the recommendations are provided in video form. The display 1752 may also be used, in some embodiments, to view a transcript of the recommendation. Speakers, headphones, or the like may be used to listen to one or more recommendations. In some embodiments, the receiver client 1750 may be a phone, a smart phone, mobile device, tablet computer, laptop computer, net book, or the like.

Each of the above methods may be executed on one or more processors on one or more computer systems. Embodiments may include various forms of distributed computing, client/server computing, and cloud based computing. Further, it will be understood that for each flow chart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which implementations may be generally referred to herein as a “circuit,” “module,” or “system.”

A programmable apparatus which executes any of the above mentioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM, Flash, MRAM, FeRAM, or phase change memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

1. A computer implemented method for voice storage comprising:
defining a reference object for which a reference is to be provided;
receiving a voice recording, which is for the reference, from a reference granter;
associating the voice recording with the reference object;
generating an icon corresponding to the voice recording;
associating the icon with the voice recording; and
displaying the icon on a webpage that is viewable to a reference receiver.

2. The method according to claim 1 further comprising obtaining a code input to identify the reference granter.

3. The method according to claim 1 wherein the reference object is one of an individual, a specialty of the individual, a company, a service of the company, and a product of the company.

4. The method according to claim 1 further comprising receiving a video recording with the voice recording.

5-6. (canceled)

7. The method according to claim 1 wherein a voice reference submission record can be deleted, but is not modifiable, by the reference granter and a reference requester.

8. The method according to claim 1 wherein the reference receiver is a different party from the reference granter and a reference requester.

9. The method according to claim 1 further comprising playing the voice recording to the reference receiver when the icon is selected.

10. The method according to claim 9 wherein the playing of the voice recording requires a password be entered in order to access the voice recording.

11. The method according to claim 1 further comprising recording the voice recording using a telephone call.

12. The method according to claim 11 wherein the recording is restricted.

13. The method according to claim 12 wherein the telephone call is restricted to be received from a pre-defined telephone number.

14. The method according to claim 12 wherein a password is required before the voice recording is recorded.

15. The method according to claim 12 wherein the voice recording is restricted to being recorded in a specific time frame.

16. The method according to claim 1 wherein the voice recording was obtained using a microphone and a computer system.

17. The method according to claim 16 further comprising recording a video of a person making the voice recording wherein the recording of the video is accomplished using a webcam.

18. The method according to claim 1 wherein the voice recording is stored on a server device and the icon is selected on a client device.

19. (canceled)

20-23. (canceled)

24. The method according to claim 1 wherein at least one of a phone number and a code number are used to prevent fraud.

25-28. (canceled)

29. A computer implemented method for voice storage comprising:
registering with a voice sharing system which stores voice recordings;
obtaining a reference ID from the voice sharing system;
receiving a phone call from a reference granter where the reference granter provides the reference ID that was received from the voice sharing system;
recording the voice of the reference granter; and
saving the recording of the voice to an audio file.

30-31. (canceled)

32. A computer implemented method for voice storage comprising:
receiving a registration from a reference requester;
receiving a reference object definition for an object on which a reference is to be provided wherein the reference object definition comes from the reference requester;
receiving a voice recording for the object from a reference granter wherein the voice recording includes a recommendation; and
providing the voice recording to a reference receiver.

33. A computer program product embodied in a non-transitory computer readable medium that, when executed, performs steps of:
defining a reference object for which a reference is to be provided;
receiving a voice recording, which is for the reference, from a voice reference granter;
associating the voice recording with the reference object;
generating an icon corresponding to the voice recording;
associating the icon with the voice recording; and
displaying the icon on a webpage that is viewable to a reference receiver.

34. A computer system for voice storage comprising:
a memory for storing instructions;
one or more processors attached to the memory wherein the one or more processors are configured to:
define a reference object for which a reference is to be provided;
receive a voice recording, which is for the reference, from a voice reference granter;
associate the voice recording with the reference object;
generate an icon corresponding to the voice recording;
associate the icon with the voice recording; and
display the icon on a webpage that is viewable to a reference receiver.
